(19) United States
(12) Patent Application Publication
(10) Pub. No.: US 2006/0031045 A1
(43) Pub. Date: Feb. 9, 2006

(54) Apparatus and methods for designing a product using a computer network

(75) Inventor: David J. Povich, Huntington Beach, CA (US)

Correspondence Address: JOHN MCCULLOCH, 5291 COLONY DRIVE NORTH, 1ST FLOOR, SAGINAW, MI, 48603, US

(73) Assignee: Ultratool International Inc

(21) Appl. No.: 11/239,846

(22) Filed: Sep. 30, 2005

Related U.S. Application Data
(63) Continuation of application No. 09/777,246, filed on Feb. 5, 2001, now abandoned.

(51) Int. Cl. G06F 17/50

(52) U.S. Cl. 703/1

(57) ABSTRACT

Product design apparatus and methods including a product database server operable to display a plurality of product styles, a plurality of customizable attributes, and a plurality of composite images. The database server is accessible by at least one client computer operable to select a product style having customizable attributes based upon choices presented by the product database server and elections made via the client computer. The product design server is operable to display a custom product design by combining a selected product style with one or more of the available attributes. Graphic displays including a composite image having the selected product style and the selected customizable attributes are transmitted via the database server to the client computer.

### RELATED APPLICATION

This application is a continuation of application Ser. No. 09/777,246, filed Feb. 5, 2001.

### TECHNICAL FIELD

The preferred embodiment of the disclosed invention applies generally to apparatus and methods for designing tools, such as carbide rotary tools (CRT) and facilitating the ordering of such tools.

### BACKGROUND OF THE INVENTION

Computer numerically controlled (CNC) machines are widely used in industry to manufacture components or parts from different types of materials. These machines typically include a rotary spindle mechanism having a tool holder at one end for holding a rotary cutting tool during a machining operation. It often is desirable to create a custom rotary tool for use in CNC machining. To create the custom tool properly several values must be known: (1) the rotary tool style, (2) the diameter and over-all length, (3) the length of cut, (4) an end style, (5) a coating type, and (6) whether there is a flat or reduced cutting diameter and/or an added neck for clearance.

Heretofore a custom tool designing and ordering process typically required an average of two to three days. The process involved a chain of information between a client or customer, an outside distributor or salesperson to an inside distributor or salesperson and then to a tool manufacturer. This process would then proceed back and forth through the chain.

It is an objective of the disclosed invention to have the custom tool design and order process occur on-line, in real-time, with the added benefit of a final specification or print of the tool being generated to the customer-defined specifications. Thus, the custom tool designing and ordering process that historically required several days to complete can now be accomplished in a few minutes on-line, without the need for the aforementioned chain and with a reduced number of personnel.

### SUMMARY OF THE DISCLOSURE

A product design apparatus and method according to the invention has a product database server operable to provide a plurality of product styles, a plurality of customizable attributes, and a plurality of composite images. There is at least one customer or client computer capable of accessing the product server and selecting the product styles and the customizable attributes based upon choices presented by the product database server and decisions made via the client computer. The product design server is operable to provide a custom product design by combining a selected product style with a plurality of selected attributes. The product database server is operable to generate graphic images of available product styles and the customizable attributes for display on the client computer. The product database server also is operable to provide a composite image representing a combination of the representations from which the user can view a finalized product.

### THE DRAWINGS

These and other features and advantages of the invention are disclosed in the accompanying drawings wherein:

FIG. 1 illustrates a topology of a global network with a product database server, a client computer, and a product manufacturer connected to the network in accordance with the preferred embodiment;

FIG. 2 illustrates a web page displaying a begin screen;

FIG. 3 illustrates a web page displaying an information-gathering screen;

FIG. 4 illustrates a web page displaying a design-system screen;

FIG. 5 illustrates a general flow-of-control to create a cost-estimate;

FIG. 6 illustrates a web page displaying a tool-style selection screen;

FIG. 7 illustrates a web page displaying a dimension selection screen;

FIG. 8 illustrates a flow-of-control of a LOC Subroutine;

FIG. 9a illustrates a web page displaying a general customization screen;

FIG. 9b illustrates a web page displaying a customization screen with a text-box to input a radius-end value;

FIG. 9c illustrates a flow-of-control of a Radius-Value Subroutine;

FIG. 9d illustrates a web page displaying a customization screen with a text-box to input a rLOC value;

FIG. 9e illustrates a flow-of-control of a Reduced-Cutting-Diameter Subroutine;

FIG. 9f illustrates a web page displaying a customization screen with a text-box to input rLOC values and a text box to input neck-values;

FIG. 9g illustrates a flow-of-control of a Neck-Value Subroutine;

FIG. 10 illustrates a web page displaying a quantity selection screen; and

FIG. 11 illustrates a web page displaying a final specification screen.

### DETAILED DESCRIPTION

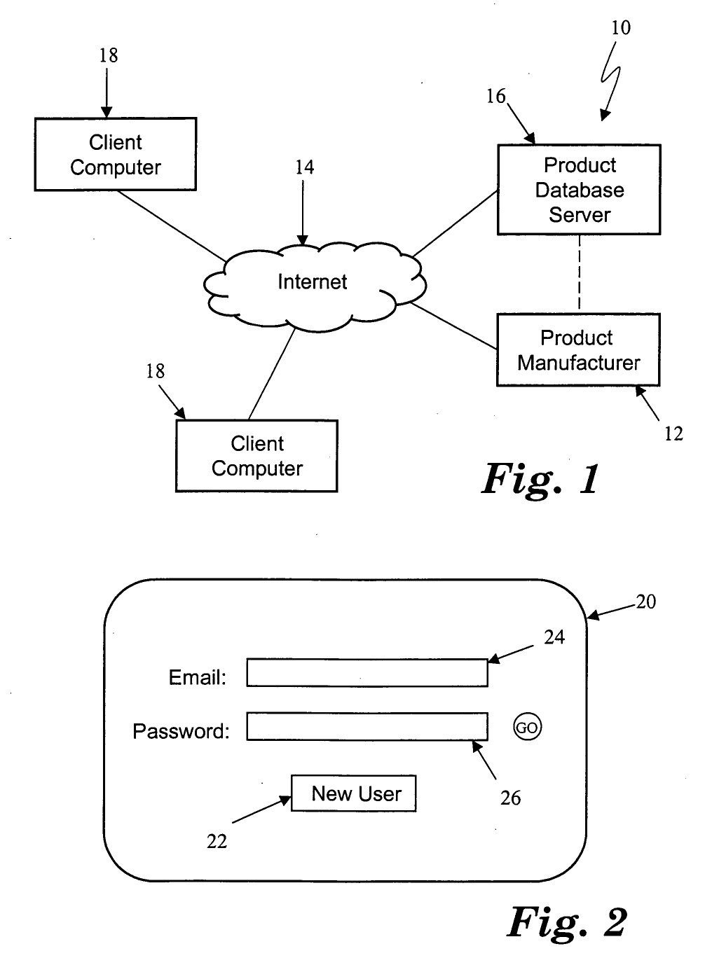

Apparatus and a method according to the invention are illustrated in FIG. 1. The several components of apparatus are designated generally by the reference character 10 and include, in general, a product manufacturer 12 providing access to a publicly accessible global computer network 14, such as the Internet, having a database 16 maintained on a server connected to the Internet. For example, a Lotus Domino® Server can be used to provide a publicly accessible web interface into the database 16. The product database server 16 can be accessed via the Internet from a client computer 18 anywhere in the world, thereby enabling anyone with Internet access to enter his own product specifications into the database 16.

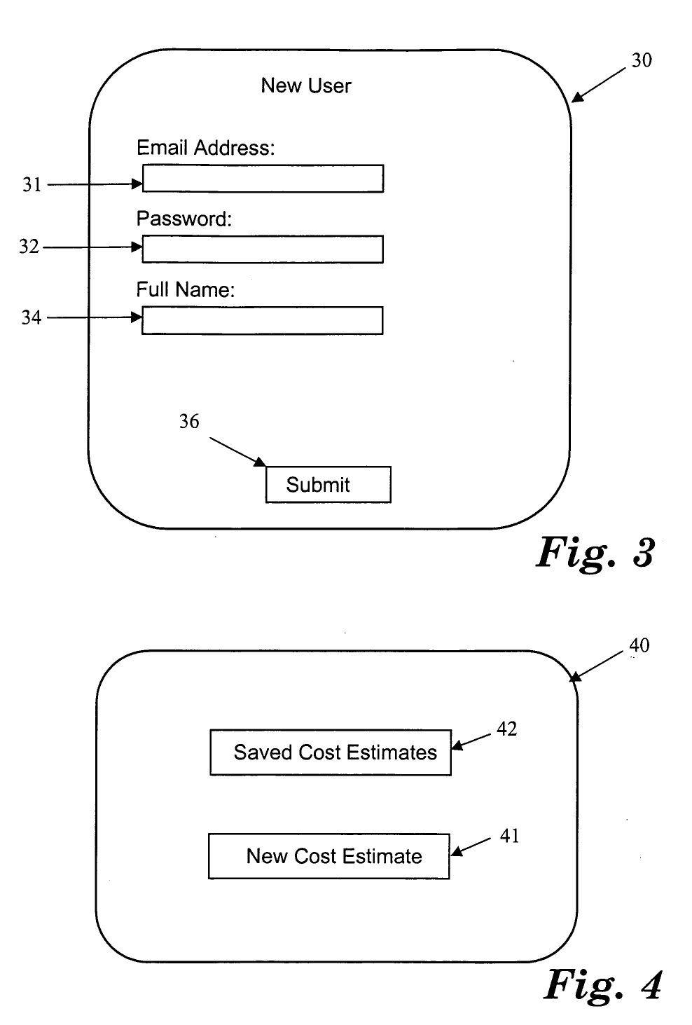

A user begins by connecting to the apparatus 10 by utilizing an HTTP enabled browser over the global computer network 14. Referring to FIG. 2, the user is prompted with a begin screen 20 to login as a current user, or to create a user account 22. If the user chooses to create the new user account, he will be prompted with an information-gathering screen 30, as shown in FIG. 3, to gather a plurality of required information about the user. The required information includes an external email address 31, a system password 32 and full name 34. The user's external email address 31 will be the user account name that the client will use to identify himself when accessing the design system 10. Once the user creates an account the design system 10 returns the user to the begin screen 20. If the user does not create the new user account, the begin screen 20 is available to continue through the design system 10. To login as a current user, the user must enter the external email address 31 in a user-account-text box 24, and the design system password 32 in a CRT-design-system-password-text box 26.

Once the user submits a valid user account name and design password, the design system 10 displays a screen 40 with at least two screen choices 41,42 as shown in FIG. 4. A first screen choice enables selections of a new cost-estimate 41 by clicking on the associated hyperlink. A second screen choice enables the selection of the ability to view a plurality of saved cost-estimates 42 by clicking on the associated hyperlink. Other sample screen choices can provide the user with technical information, contact information, company information, or additional information on product quality by simply clicking on the associated hyperlinks.

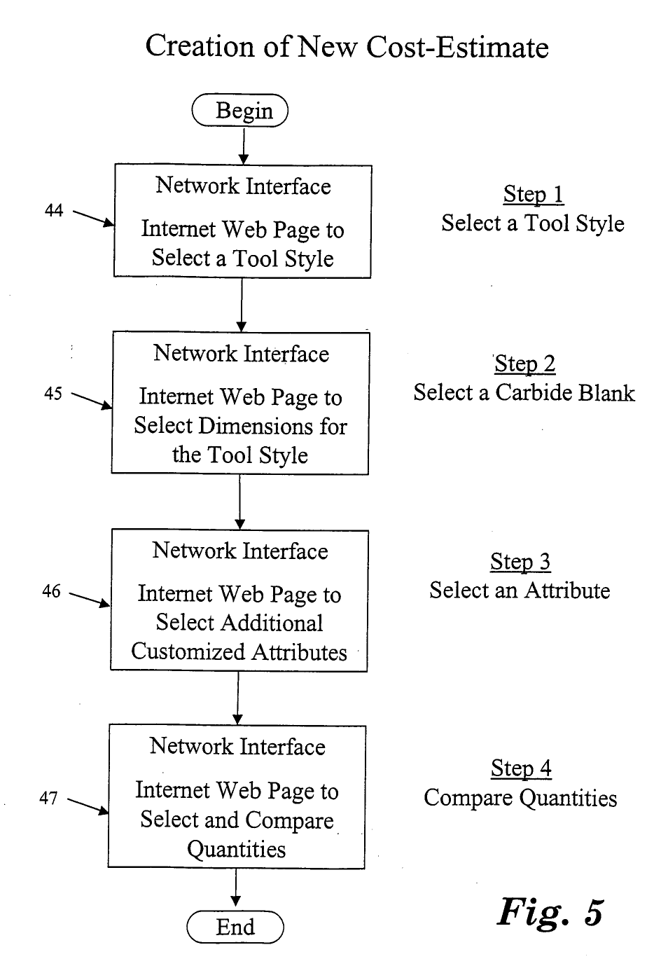

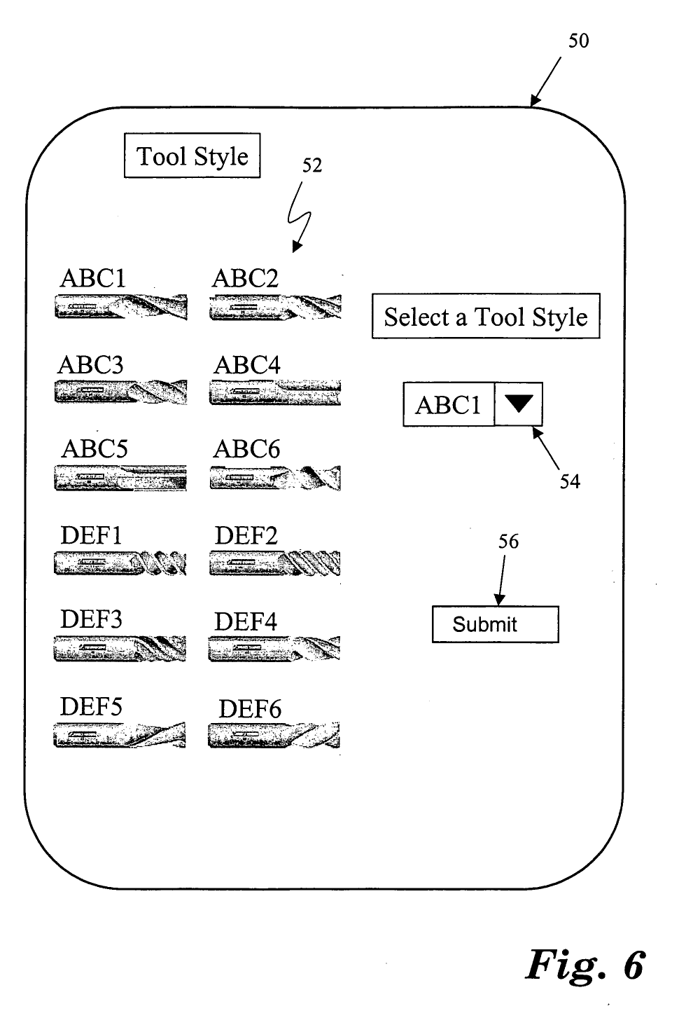

In FIG. 5 there are shown the data sources and general flows to create a new cost estimate. Creating the new cost estimate for the design system 10 takes four steps 44, 45, 46, 47, beginning with step one 44, selecting a tool-style. As shown in FIG. 6, a tool-style web page 50 contains a plurality of graphical representations 52 of the product manufacturer's stock tool designs. The user selects the desired tool-style by clicking on the graphic representation 52 or from a drop-down selection list, generally indicated at 54. The user clicks a submit button 56 to continue to step two and the next web page in the design system 10. Data indicating the user account name and the selected tool-style are transmitted to the next step for additional customization of the tool-style, using programming techniques already known in the art.

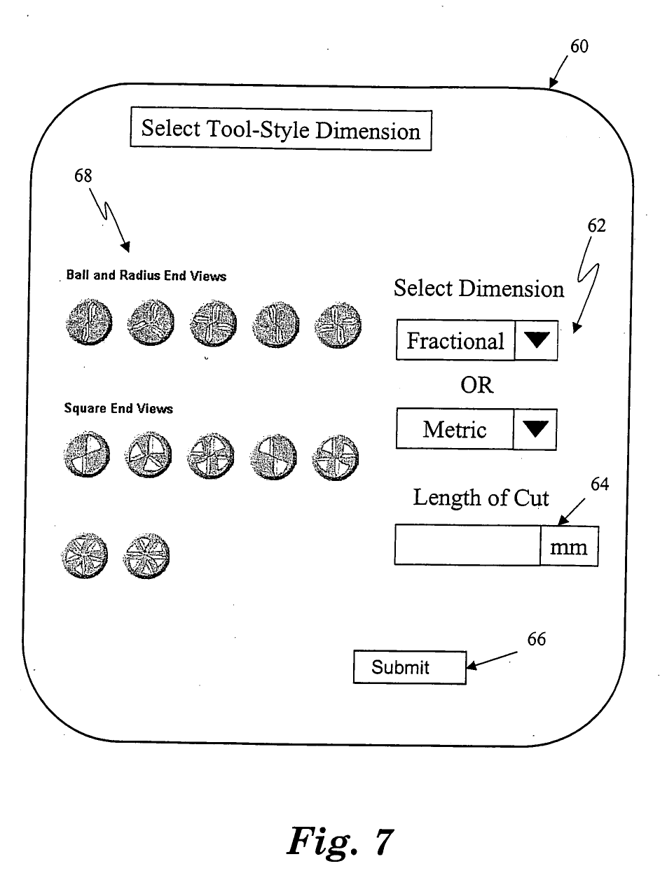

In step two 45 as illustrated in FIG. 7, the user selects a dimension for the previously designated tool-style on a dimension selection screen 60. The user selects the desired tool-style dimension by clicking on the graphic representation or from a drop-down dimension-selection list, generally shown at 62. The dimension list is static based upon the manufacturer's capability to produce the tool. The form of the dimension measurement is diameter (D) by overall-length (OAL), or D×OAL. The user can select the dimension in either fraction (English) or metric dimensions.

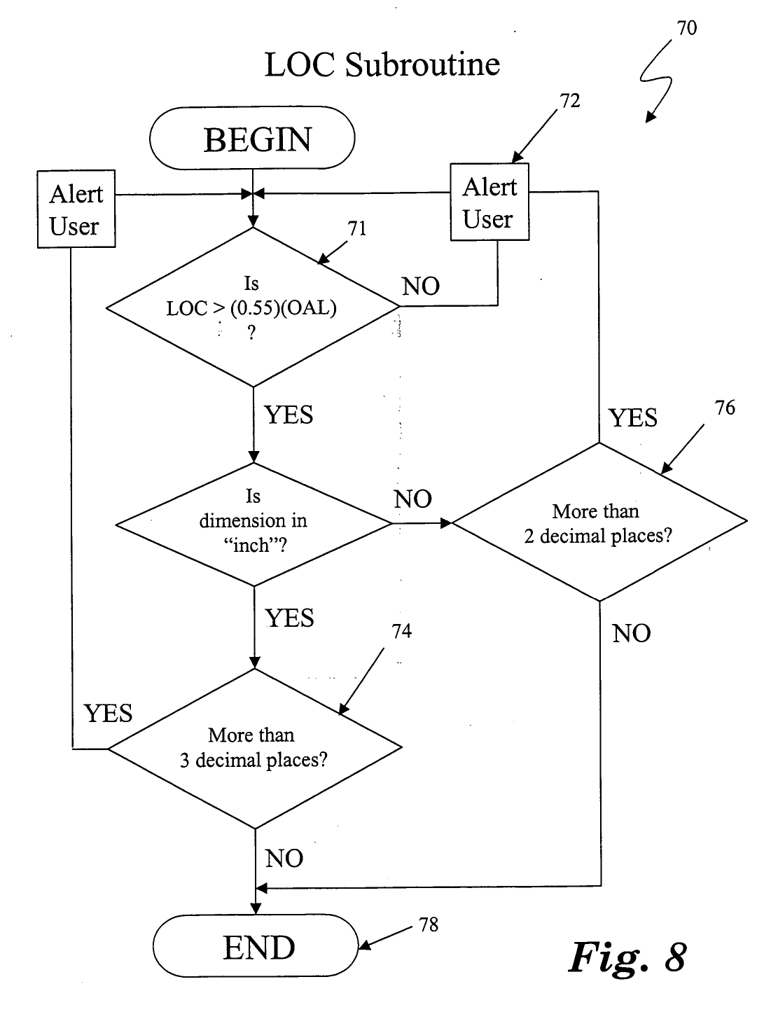

At this stage it is possible to include a plurality of manufacturer-defined settings that the user may customize. One example of the manufacturer-defined setting includes a length of cut (LOC). The user enters a LOC value in a LOC text box 64. Using programming techniques known in the art, a LOC validation subroutine 70 validates the LOC to ensure it is not too large for the dimension selected with data flows illustrated in FIG. 8. The LOC validation subroutine 70 multiplies the OAL by a manufacturer-defined LOC percentage that is preferably less than 55%, but can be any value up to 55%, but not exceeding 56%. Thus, if the LOC is greater than preferably 55% of the OAL 71, then the LOC is too large, and the LOC subroutine alerts the user 72 and requests the user to enter another value for the LOC. The design system 10 also restricts the value of the LOC to three decimal places if the LOC is in English 74, or two decimal places if the LOC is in metric 76. The LOC validation subroutine continues to alert the user 72 until the LOC is validated. Once the LOC validation subroutine has properly validated 78 the data entered by the user, the user then clicks a submit button 66 to proceed to step three and the next web page in the design system 10. Data indicating the user account name, the selected tool style, and the customized dimensions (D, OAL, and LOC) are transmitted to the next step for additional customization of the tool style, using programming techniques already known in the art.

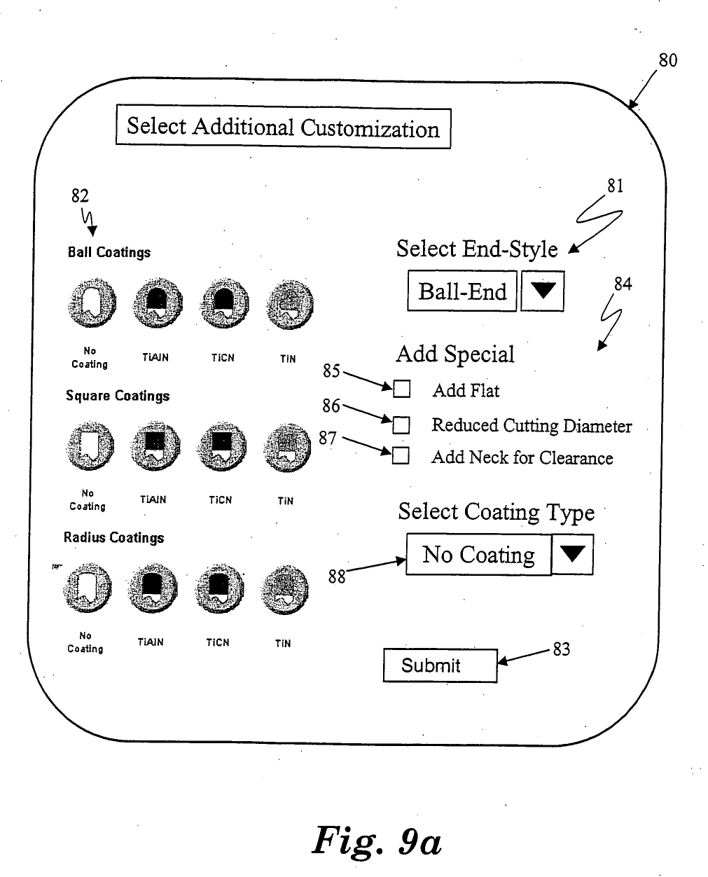

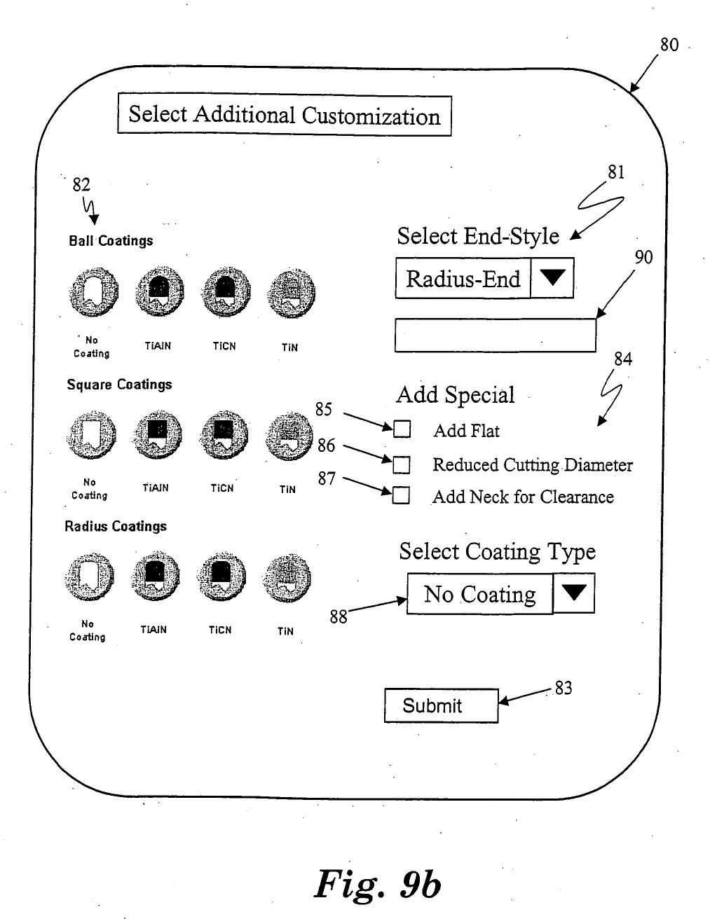

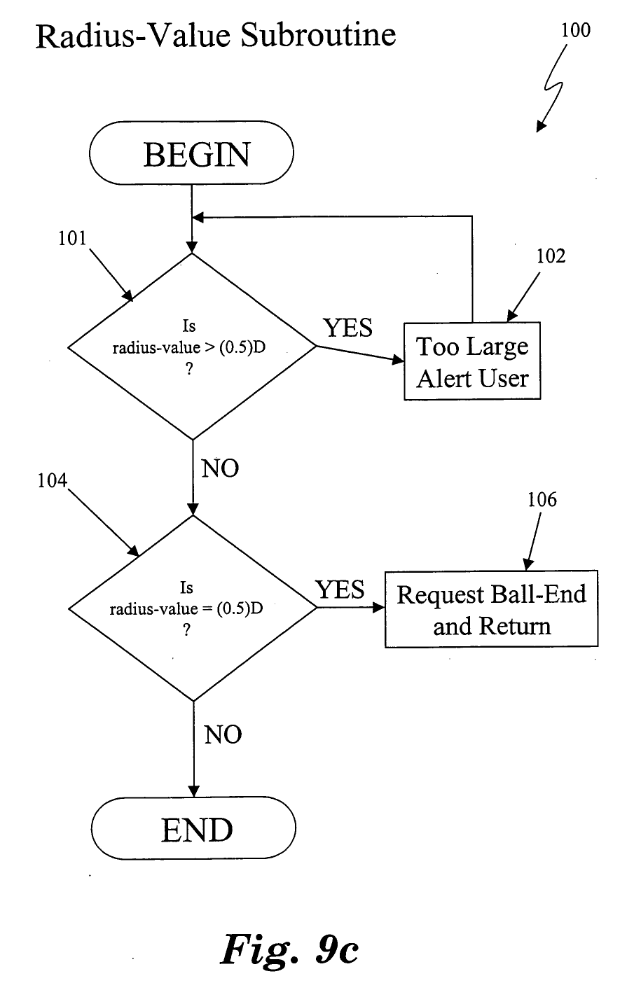

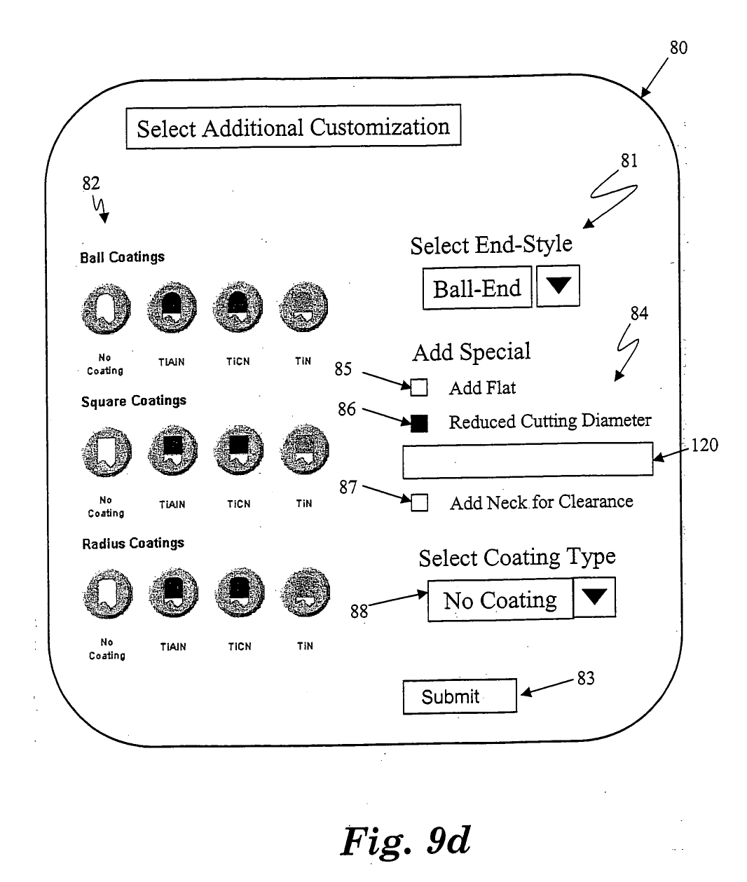

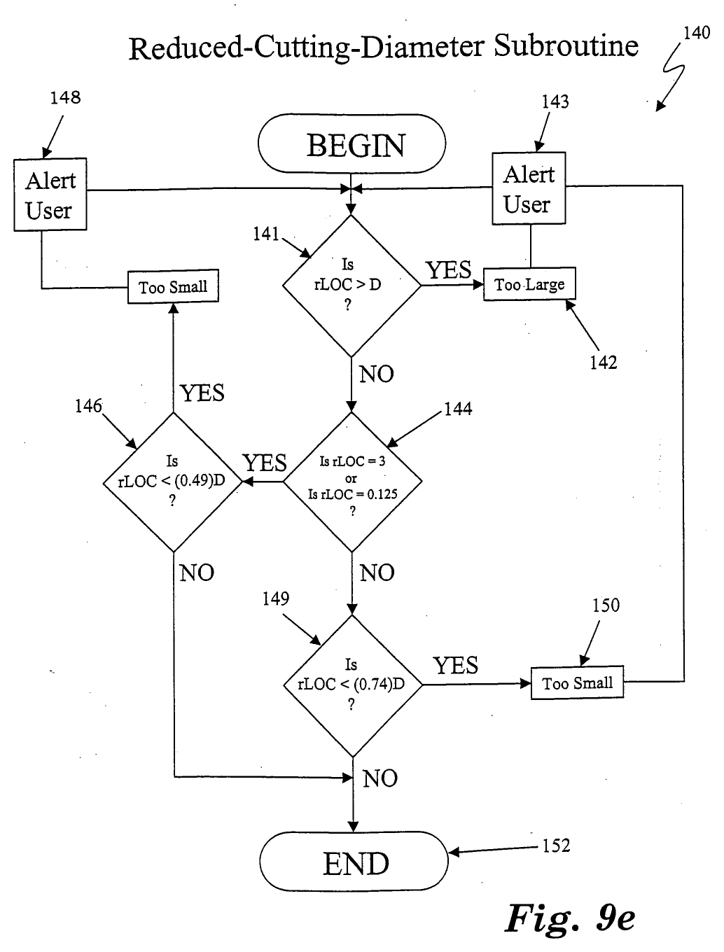

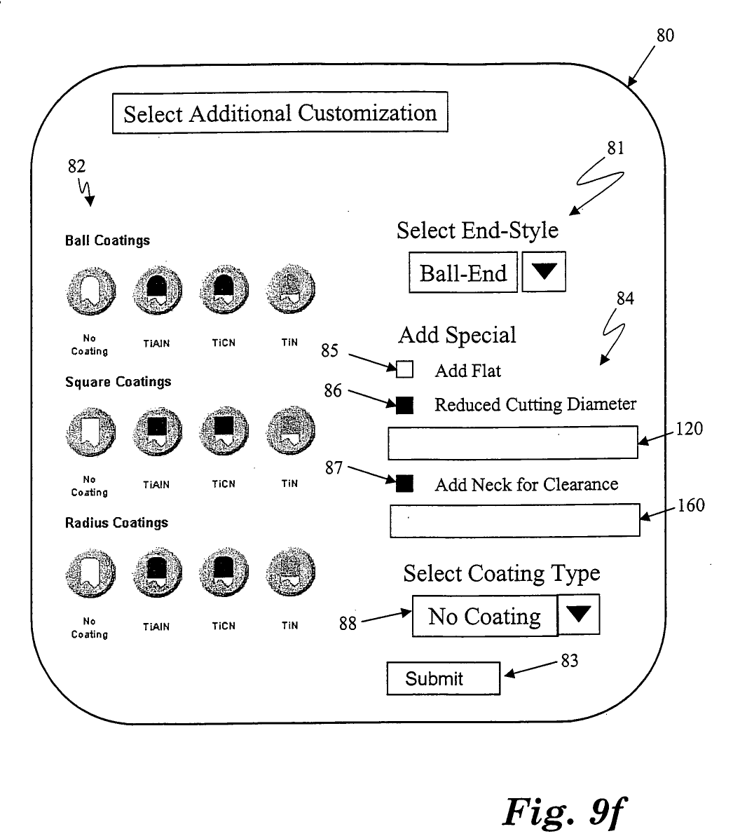

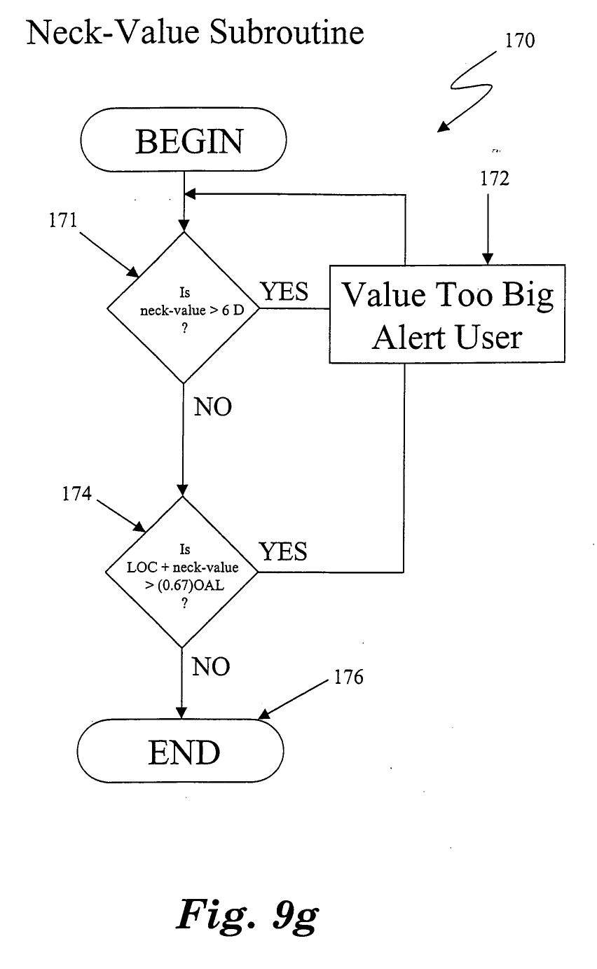

Step three 46 illustrated in FIG. 9a is the additional attribute customization step. In the preferred embodiment, a customization web page 80 with step three 46 contains at least one sub-step, but preferably three. In sub-step one of step three 46, generally shown at 81, the user can select one of three end styles generally shown at 82: (1) a ball-end, (2) a square-end, and (3) a radius-end. If either the ball-end or the square-end is selected, the design system does not validate the user's choice because the ball-end and the square-end have predefined values. However as illustrated in FIG. 9b, if the radius-end is specified, the design system 10 displays a text box 90 to enter a radius-value. A radius-value subroutine 100 validates the radius-value to ensure the radius-end is not too large with data flow illustrated in FIG. 9c. The radius-value subroutine checks if the radius end is greater than 50% of the diameter 101, then the subroutine determines the radius value is too large 102 and the user must enter a smaller value. But if the radius end is equal to 50% of the diameter 104, then the subroutine requests the user to select the ball end 106.

As shown in FIG. 9d, sub-step 2 has additional manufacturer-specific requirements, generally shown at 84: (1) a flat 85, (2) a reduced-cutting-diameter 86, and (3) a neck-for-clearance 87. If the user selects to include the flat 85, the design system 10 does no additional validation.

However, if the user selects to add the reduced-cutting-diameter 86, also referred to as the rLOC, the design system 10 presents the user with a text box 120 to specify a rLOC value. FIG. 9e illustrates data flow for a reduced-cutting-diameter subroutine 140 that validates the rLOC value. The reduced-cutting-diameter subroutine checks whether rLOC>D at 141, and if so the reduced-cutting-diameter subroutine signals the rLOC value is too large 142 and activates the alert user 143. Additionally, the reduced-cutting-diameter subroutine checks if D=3 or D=0.125 at 144, then if the rLOC value<49% of the diameter 146, the rLOC value is too small 147 and a signal is sent to the alert user 148. Otherwise if the rLOC value<74% of the diameter 149, the rLOC value is too small 150 and the alert user 143 is activated. If the rLOC value is neither too small nor too large, the reduced-cutting-diameter subroutine validates 152 the rLOC value and stores it as one of the customizable attributes.

If the user selects to add the neck-for-clearance 87 as illustrated in FIG. 9f, the design system 10 presents the user with a text box 160 to specify a neck-value. A neck-value subroutine 170 validates the neck-value. If the neck-value>6 times the diameter 171, then the neck-value is too large and the subroutine alerts the user 172. If the LOC+the neck-value>2/3 the OAL 174, then the neck-value is also too large and the subroutine alerts the user 172. Otherwise, if the neck-value is not too large, the neck-value subroutine validates the neck-value and stores it as another of the customizable attributes.

Finally, in sub-step three and referring back to FIG. 9a, the user can select another customizable attribute, namely, a coating type, generally shown at 82. Possible coating selections include, but are not limited to: (1) no coating, (2) TiAiN, (3) TiCN, and (4) TiN. A plurality of graphic representations 82 are presented to aid in selecting the additional customized attributes. The user selects the coating type by clicking on the graphic representation 82 or from a drop-down selection list 88. The user clicks a submit button 83 to continue to step four and the next web page in the tool design system 10. Data indicating the user account name, the selected tool-style, the customized dimensions (D, OAL, and LOC), the added flat (if selected), the rLOC value (if selected), the neck-value (if selected), and the coating type are transmitted to the next step, using programming techniques already known in the art, for additional customization of the tool-style.

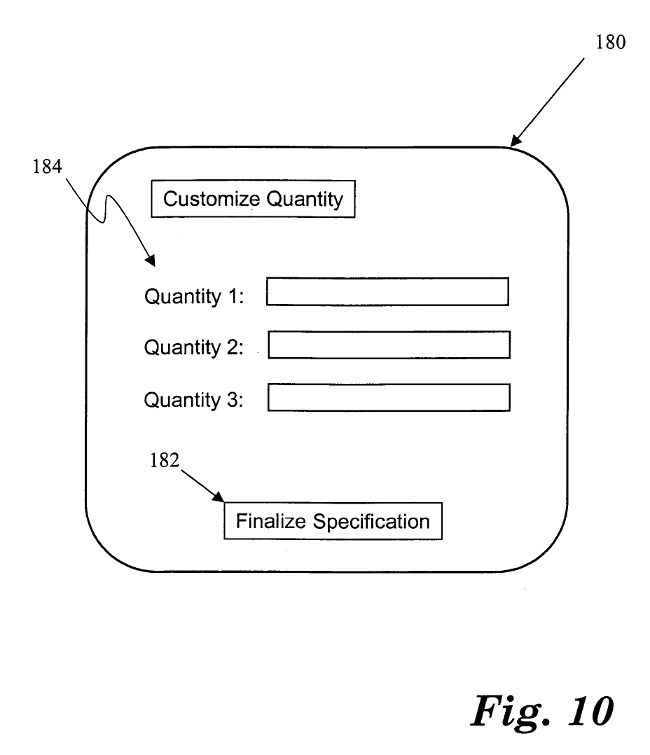

In step four, the tool design system displays to the user a quantity selection screen 180, as illustrated in FIG. 10 where the user inputs a plurality of quantities, generally shown at 184, to preview different price quotes based on the different quantities. Data indicating the user account name, the selected tool-style, the customized dimensions (D, OAL, and LOC), the added flat (if selected), the rLOC (if selected), the neck-value (if selected), the coating type, and the user-selected quantities are transmitted to a final specification result page, using programming techniques already known in the art. The user then finalizes the tool-style quotation to create a final specification by clicking a submit button 182 to proceed to a final specification and a next web page in the tool design system 10.

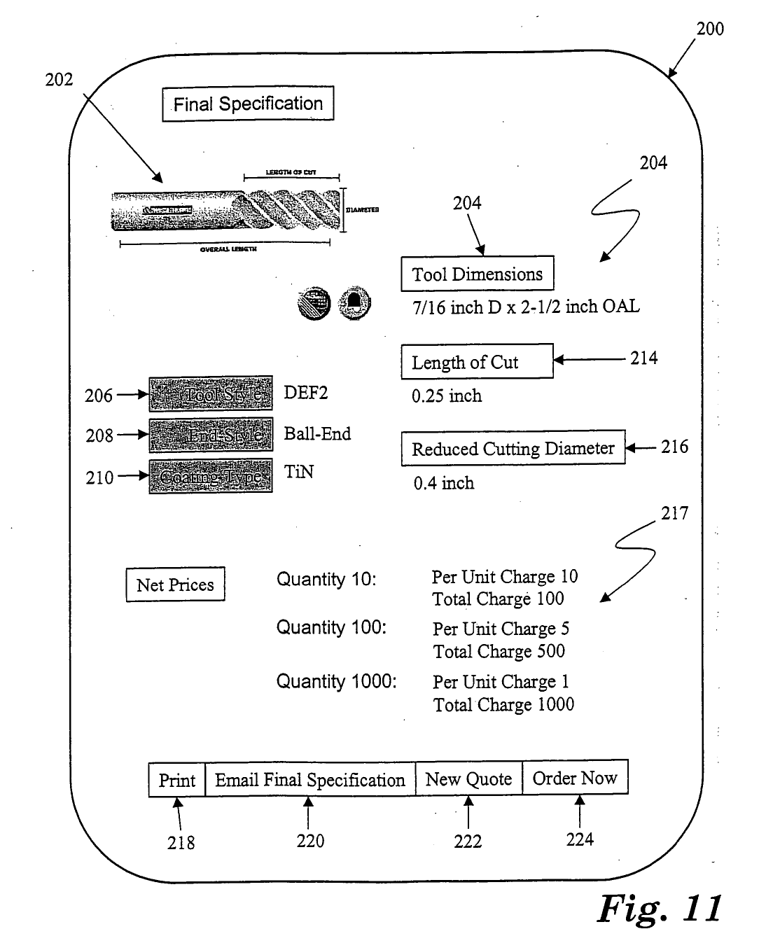

As illustrated in FIG. 11, a final specification web page 200 displays a graphic 202 that is a representation of the custom designed tool, as well as a plurality of numerical values 204 necessary to produce the tool. A graphic tool file name for the graphic 202 is created by concatenating a plurality of codes from the data obtained from steps one through three. The typical format is: a tool-style code+a customized attribute code+image format. For example, if the specification results in a tool design having five 45° flutes for stainless steel, nickel and titanium alloys, the tool-style code could be DEF2. If the tool further has a ball-end, and a reduced-cutting-diameter, the corresponding customized attribute codes are B, and rD, respectively. Thus, the displayed graphic 202 would be ABC1BrD.jpeg. However, it is possible to create the finalized graphic representation utilizing known programming techniques and object-oriented programming languages like Java®. The data from the previous three steps are also included on the final specification: the tool-style 206, the end-style 208, the coating-type 210, the dimensions 204, the LOC 214, flat (if selected), rLOC 216 (if selected), the neck-value (if selected), and the sample quantities 217.

Once created, the specification becomes associated with the user account name, and is available according to a LIFO stack of saved specifications. The user can: (1) print the specification by pressing a print button 218, (2) email the specification to the external email address 30 by pressing an email button 220, (3) create a new quote, thereby returning to step one 44, by pressing a new-create new-quote button 222, or (4) order the rotary tool based upon the final specification with the prices shown for the desired quantities by pressing an order-now button 224.

The disclosure is representative of the presently preferred apparatus and methods, but is intended to be illustrative rather than definitive thereof. The invention is defined in the claims.

I claim:

1. Cutting tool design apparatus operable by a client comprising:
a database server operable to provide a plurality of cutting tool styles, a plurality of customizable attributes, and a plurality of composite images;
at least one client computer for enabling the client to access the database server to select a cutting tool style and the customizable attributes based upon choices presented by the database server and submissions made by the client via the client computer,
the database server being operable to provide a custom cutting tool design by combining a selected one of the cutting tool styles with a selected plurality of the attributes as submitted via the client computer; and
a plurality of graphic representations illustrative of the cutting tool styles and the customizable attributes, said database server being operable to display said cutting tool styles and the submitted customizable attributes on the client computer from which the client may select a desired cutting tool style and the submitted customizable attributes by clicking on the desired cutting tool style and the submitted customizable attributes,
said database server being operable to provide a composite image representing a cutting tool having the selected style and the submitted attributes.

2. The design apparatus according to claim 1 wherein the database server and the client computer are connected by a TCP/IP compliant protocol.

3. The design apparatus according to claim 1 wherein the database server is operable to display a plurality of quantity choices of the cutting tool having the selected custom design.

4. The design apparatus according to claim 1 wherein the database server is operable to display the custom design cutting tool having the composite image, the cutting tool style, the submitted customized attributes, and the quantity choices.

5. The design apparatus according to claim 1 wherein the client computer is operable to submit the custom design cutting tool to the database server to initiate an order for said cutting tool.

6. A cutting tool design method using sequential computer screens to create a final cutting tool according to a predetermined one of a plurality of available specifications comprising:
(a) graphically displaying a plurality of cutting tool styles and a plurality of customization attributes on a plurality of said sequential computer screens;
(b) selecting one of said cutting tool styles and one or more of said attributes from the display of cutting tool styles and customizable attributes by clicking on a desired cutting tool style and customizable attribute;
(c) producing an image of a final cutting tool having the selected style and the selected attributes; and
(d) displaying said image and cutting tool specification information based on the selected cutting tool style and customizable attributes.

7. The method according to claim 6 including sending the cutting tool specification information to a receiver by email.

8. The method according to claim 7 wherein said receiver is a supplier of said final cutting tool.

9. An article of manufacture comprising:
a computer readable medium having a computer readable program code embodied thereon, said computer readable program being configured to perform the steps of:
graphically displaying a plurality of selectable cutting tool styles and a plurality of selectable cutting tool customizable attributes on a computer screen;
receiving selected cutting tool style and cutting tool customizable attribute information from the display of said cutting tool styles and said cutting tool customizable attributes;
selecting a desired cutting tool style and one or more cutting tool customizable attributes using the received information;
incorporating the selected customizable cutting tool attributes into the selected cutting tool style; and
displaying the selected cutting tool style and incorporated customizable cutting tool attributes together with product specification information based on the received information.

10. A cutting tool design system operable by a client, comprising:
a cutting tool database server operable to graphically display a selected one of a plurality of cutting tool styles, a plurality of cutting tool customizable attributes, and a plurality of composite images on a computer screen;
at least one client computer operable to access the cutting tool database server and select a cutting tool style and one or more customizable cutting tool attributes based upon choices presented by the cutting tool database server and decisions made by said client via the client computer;
said cutting tool database server being operable to display a custom designed cutting tool by combining a selected one of the cutting tool styles with the selected cutting tool attributes from the graphical display; and
a plurality of graphic representations illustrative of a custom designed tool having the selected cutting tool style and the selected cutting attributes, said custom designed tool being displayable on the client computer.

11. The design system according to claim 10 wherein the cutting tool database server and the client computer are connected by a TCP/IP compliant protocol.

12. The design system according to claim 10 wherein the cutting tool database server displays a plurality of quantity choices for the custom designed cutting tool.

13. The design system according to claim 10 wherein the cutting tool database server displays the custom designed cutting tool as a composite image incorporating the cutting tool style, the customized attributes, and the quantity choices.

14. The design system according to claim 10 wherein the client computer is operable to submit the custom designed cutting tool to the cutting tool database server to initiate an order for said custom designed tool.

15. A method of using sequential computer screens to custom design a cutting tool according to a specification originating with a client comprising:
(a) graphically displaying a plurality of cutting tool styles and a plurality of customizable cutting tool attributes originated by said client on a computer screen using a plurality of sequential images;
(b) selecting one of said cutting tool styles and one or more of said cutting tool customizable attributes from the graphical display by clicking on the selected cutting tool style and customizable cutting tool attributes;
(c) creating a cutting tool image having the selected cutting tool style and customizable cutting tool attributes; and
(d) displaying said cutting tool image on one of said screens.

16. The method according to claim 15 including displaying on said one of said screens selected specifications relating to a cutting tool corresponding to said cutting tool image.

17. The method according to claim 16 including transmitting to a receiver by email the displayed cutting tool image and the specification displayed on said selected screen.

18. The method according to claim 17 wherein said receiver is a cutting tool supplier.

19. The method according to claim 15 wherein the selected cutting tool style has a body having a diameter and a selected one of: a ball end having a value greater than 50% of the diameter; a square end; and a corner-radius end having a value less than 50% of the diameter.

20. The method according to claim 19 wherein the selected cutting tool style has a flat, a reduced cutting diameter, and a neck.

21. The method according to claim 15 wherein the selected cutting tool style is formed of carbide.

22. An article of manufacture comprising:
a computer readable medium having a computer readable program code embodied thereon for enabling a client to custom design a cutting tool, said computer readable program code being operable to perform the steps of:
graphically displaying a plurality of carbide rotary cutting tool styles and a plurality of customization attributes on a computer screen as a plurality of sequential images;
receiving user-selected carbide rotary cutting tool styles and customizable cutting tool attribute information of a selected cutting tool style from the graphical display;
creating a selected cutting tool image using the received information; and
displaying the selected cutting tool image along with specification information related to said selected cutting tool image and based on the received information.
